(19) United States
(12) Patent Application Publication
(10) Pub. No.: US 2023/0359868 A1
(43) Pub. Date: Nov. 9, 2023

(54) FEDERATED LEARNING METHOD AND APPARATUS BASED ON GRAPH NEURAL NETWORK, AND FEDERATED LEARNING SYSTEM

(71) Applicant: Alipay Labs (Singapore) Pte. Ltd., Singapore (SG)

(72) Inventor: Tiehua ZHANG, Hangzhou (CN)

(21) Appl. No.: 18/312,510

(22) Filed: May 4, 2023

(30) Foreign Application Priority Data
May 5, 2022 (CN) 202210481764.1

(51) Int. Cl. G06N 3/045; G06N 3/047

(52) U.S. Cl. CPC G06N 3/045; G06N 3/047

(57) ABSTRACT

Implementations of the present specification provide a federated learning method and apparatus based on a graph neural network, and a federated learning system. In the federated learning method, each first member device performs mining of graph nodes and mining of a relationship among graph nodes on local spatial-temporal data to generate graph-structured data; trains a local graph neural network model by using the graph-structured data, to obtain update amount information; and sends the update amount information to a second member device; and the second member device receives the update amount information sent by each first member device; obtains combined update amount information based on the received update amount information; and separately sends corresponding model update information to each first member device based on the combined update amount information for each first member device to update the local graph neural network model based on the corresponding model update information.

### TECHNICAL FIELD

Implementations of the present specification relate to the field of artificial intelligence technologies, and for example, to federated learning.

### BACKGROUND

Federated learning is an emerging fundamental artificial intelligence technology designed to combine a plurality of data terminals for machine learning training without central training data. During federated learning, a plurality of data terminals collaboratively train a shared global model while ensuring that training data is at the terminal.

### SUMMARY

Implementations of the present specification provide a federated learning method and apparatus based on a graph neural network, and a federated learning system. In the technical solution, a model based on a graph neural network is trained in a federated learning framework, and association features between spatial-temporal data used as training samples are fully mined for model training. In addition, federated learning ensures security of local spatial-temporal data of each first member device.

According to an aspect of the implementations of the present specification, a federated learning method based on a graph neural network is provided. The federated learning method is performed by a federated learning system. The federated learning system includes at least two first member devices and a second member device. Each first member device has spatial-temporal data used to train a local graph neural network model. The federated learning method includes: by each first member device, performing mining of graph nodes and mining of a relationship among graph nodes on local spatial-temporal data to generate graph-structured data including graph nodes as vertices and graph node relationships as edges; training the local graph neural network model by using the graph-structured data, to obtain update amount information for the local graph neural network model; and sending the update amount information to the second member device; and by the second member device, receiving the update amount information sent by each first member device; obtaining combined update amount information based on the received update amount information; and separately sending corresponding model update information to each first member device based on the combined update amount information for each first member device to update the local graph neural network model based on the corresponding model update information.

According to another aspect of the implementations of the present specification, a federated learning method based on a graph neural network is further provided. The federated learning method is performed by a first member device in a federated learning system. The federated learning system includes at least two first member devices and a second member device. Each first member device has spatial-temporal data used to train a local graph neural network model. The federated learning method includes: performing mining of graph nodes and mining of a relationship among graph nodes on local spatial-temporal data to generate graph-structured data including graph nodes as vertices and graph node relationships as edges; training the local graph neural network model by using the graph-structured data, to obtain update amount information for the local graph neural network model; sending the update amount information to the second member device for the second member device to obtain combined update amount information based on the received update amount information, and to separately send corresponding model update information to each first member device based on the combined update amount information; and updating the local graph neural network model based on the corresponding model update information.

According to another aspect of the implementations of the present specification, a federated learning apparatus based on a graph neural network is further provided, applied to a first member device in a federated learning system. The federated learning system includes at least two first member devices and a second member device. Each first member device has spatial-temporal data used to train a local graph neural network model. The federated learning apparatus includes: a data mining unit, configured to perform mining of graph nodes and mining of a relationship among graph nodes on local spatial-temporal data to generate graph-structured data including graph nodes as vertices and graph node relationships as edges; a model training unit, configured to train the local graph neural network model by using the graph-structured data, to obtain update amount information for the local graph neural network model; an information sending unit, configured to send the update amount information to the second member device for the second member device to obtain combined update amount information based on the received update amount information, and to separately send corresponding model update information to each first member device based on the combined update amount information; and a model update unit, configured to update the local graph neural network model based on the corresponding model update information.

According to another aspect of the implementations of the present specification, a federated learning system is further provided, including at least two first member devices and a second member device. Each first member device has spatial-temporal data used to train a local graph neural network model. Each first member device and the second member device are configured to implement any one of the federated learning methods based on a graph neural network.

According to another aspect of the implementations of the present specification, an electronic device is further provided, including: at least one processor, a memory coupled to the at least one processor, and a computer program stored in the memory. The at least one processor executes the computer program to implement any one of the federated learning methods based on a graph neural network.

According to another aspect of the implementations of the present specification, a computer-readable storage medium is further provided. The computer-readable storage medium stores a computer program. When the computer program is executed by a processor, any one of the federated learning methods based on a graph neural network is implemented.

According to another aspect of the implementations of the present specification, a computer program product is further provided, including a computer program. When the computer program is executed by a processor, any one of the federated learning methods based on a graph neural network is implemented.

### BRIEF DESCRIPTION OF DRAWINGS

Further understanding of the essence and advantages of the content of the implementations of the present specification can be implemented by referring to the following accompanying drawings. In the accompanying drawings, similar components or features can have the same reference numeral.

FIG. 1 is an example structural diagram illustrating a federated learning system according to an implementation of the present specification;

FIG. 2 is a signal communication diagram illustrating an example of a federated learning method based on a graph neural network according to an implementation of the present specification;

FIG. 3 is a schematic diagram illustrating an example of performing mining of graph nodes and mining of a relationship among graph nodes on spatial-temporal data according to an implementation of the present specification;

FIG. 4 is a flowchart illustrating an example of a federated learning method based on a graph neural network according to an implementation of the present specification;

FIG. 5 is a block diagram illustrating an example of a federated learning apparatus based on a graph neural network according to an implementation of the present specification; and

FIG. 6 is a block diagram illustrating an electronic device for implementing a federated learning method according to an implementation of the present specification.

### DESCRIPTION OF IMPLEMENTATIONS

The subject matter described in the present specification is discussed below with reference to example implementations. It should be understood that these implementations are merely discussed to enable a person skilled in the art to better understand and implement the subject matter described in the present specification, and are not intended to limit the protection scope, applicability, or examples described in the claims. The functions and arrangements of the discussed elements can be changed without departing from the protection scope of the content of the implementations of the present specification. Various processes or components can be omitted, replaced, or added in the examples based on needs. In addition, features described for some examples can also be combined in other examples.

As used in the present specification, the term “include” and its variant represent open terms, and mean “including but not limited to”. The term “based on” means “at least partially based on”. The terms “one implementation” and “an implementation” represent “at least one implementation”. The term “another implementation” represents “at least one another implementation”. The terms such as “first” and “second” can refer to different or same objects. The following can include other definitions, whether explicit or implicit. Unless explicitly stated in the context, the definition of a term is consistent throughout the present specification.

The term “spatial-temporal data” is spatial data that has a temporal dimension and changes with time, and the spatial-temporal data is data that has a temporal dimension and a spatial dimension.

In a federated learning architecture, each participant trains a local model by using local data, to obtain model gradient information of the participant through training. Then, each participant sends the model gradient information of the participant to a server, and the server performs gradient aggregation to obtain aggregated gradient information, and then delivers the aggregated gradient information to each participant. Therefore, each participant can update the local model by using the aggregated gradient information. In this process, each participant directly inputs the local data into the local model for training.

For the spatial-temporal data, because the spatial-temporal data has a temporal dimension and a spatial dimension, there can be association between different spatial-temporal data. In this data processing method of current model training, association between the spatial-temporal data cannot be mined by directly inputting the data into the model. As a result, an association feature between the spatial-temporal data cannot be fully and effectively used in model training, and a model training effect is less satisfying.

Implementations of the present specification provide a federated learning method and apparatus based on a graph neural network, and a federated learning system. In the federated learning method, the federated learning method is performed by a federated learning system. The federated learning system includes at least two first member devices and a second member device. Each first member device has spatial-temporal data used to train a local graph neural network model. The federated learning method includes: by each first member device, performing mining of graph nodes and mining of the association or relationship among graph nodes on local spatial-temporal data to generate graph-structured data; training the local graph neural network model by using the graph-structured data, to generate update amount information for the local graph neural network model; and sending the update amount information to the second member device; and by the second member device, receiving the update amount information sent by each first member device; obtaining combined update amount information based on the received update amount information; and separately sending corresponding model update information to each first member device based on the combined update amount information for each first member device to update the local graph neural network model based on the corresponding model update information. In the technical solution, a model based on a graph neural network is trained in a federated learning framework, and association features between spatial-temporal data used as training samples are fully mined for model training. In addition, federated learning ensures security of local spatial-temporal data of each first member device.

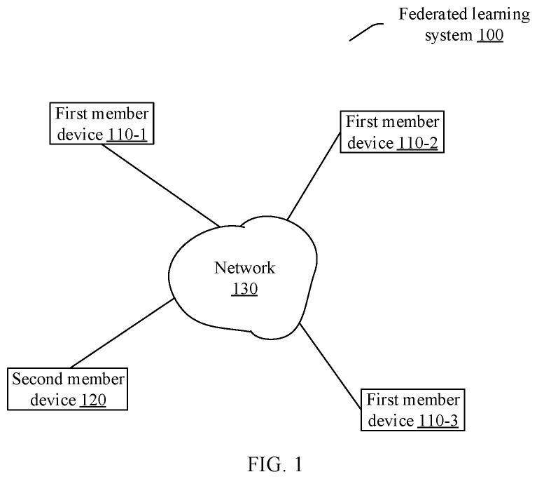

FIG. 1 is an example structural diagram illustrating a federated learning system 100 according to an implementation of the present specification.

As shown in FIG. 1, the federated learning system 100 includes at least two first member devices 110 and a second member device 120. Three first member devices 110-1 to 110-3 are shown in FIG. 1. In implementations of the present specification, more or fewer first member devices 110 can be included. The at least two first member devices 110 and the second member device 120 can communicate with each other by using a network 130 such as, but not limited to, the Internet or a local area network.

In some implementations of the present specification, the first member device 110 can be a device or a device party configured to locally collect a data sample. The second member device 120 can be a device or a device party configured to aggregate a model gradient. In the present specification, the term “first member device” and the term “data owner” or “client” can be used interchangeably for descriptive purposes. The term “second member device” and the term “model owner,” “server,” or “cloud device” can be used interchangeably for descriptive purposes.

In the present specification, local data of each of the first member devices 110-1 to 110-3 can include service data locally collected by each first member device 110. The service data can include feature data of a service object. Examples of the service object can include but are not limited to a user, a commodity, an event, or a relationship. Correspondingly, the service data, for example, can include but is not limited to user feature data, commodity feature data, event feature data, or relationship feature data that is locally collected, for example, user feature data, service processing data, financial transaction data, commodity transaction data, and medical health data. For example, the service data can be applied to a global model to perform model prediction, model training, and other appropriate multi-party data joint processing.

In the present specification, the service data can include service data based on text data, image data, and/or voice data. A service model can be applied to service risk identification, service classification, or service decision making based on text data, image data, and/or voice data. For example, the local data can be medical data collected by a hospital, and the service model can be used for disease examination or disease diagnosis. Alternatively or additionally, the collected local data can include user feature data. Correspondingly, a local model of each first member device 110 can be applied to service risk identification, service classification, service recommendation, or service decision making based on the user feature data. Examples of the local model can include but are not limited to a facial recognition model, a disease diagnosis model, a service risk prediction model, or a service recommendation model.

In the present specification, the local data of each first member device 110 is training sample data that constitutes the local model, and the local data of each first member device is a proprietary to the first member device, and cannot be known or cannot be totally known by another first member device.

In practice, in an example, each first member device 110 can be, for example, a data storage server or an intelligent terminal device of a service application party or a service application associated party, for example, local data storage servers or intelligent terminal devices of different financial institutions or medical institutions. The second member device 120 can be, for example, a server of a service provider or a service operator, for example, a server of a third-party payment platform used to provide a payment service.

In the present specification, the first member device(s) 110 and the second member device(s) 120 each can be any suitable electronic device with a computing capability. The electronic device includes but is not limited to a personal computer, a server computer, a workstation, a desktop computer, a laptop computer, a notebook computer, a mobile electronic device, a smartphone, a tablet computer, a cellular phone, a personal digital assistant (PDA), a handheld apparatus, a messaging device, a wearable electronic device, or a consumer electronic device.

In addition, the first member devices 110-1, 110-2, and 110-3 and the second member device 120 each have a federated learning apparatus. The federated learning apparatuses of the first member devices 110-1, 110-2 and 110-3 and the second member device 120 can exchange data by performing network communication by using the network 130, and therefore collaboratively perform processing to execute a model training process for the global model.

In some implementations, the network 130 can be any one or more of a wired network or a wireless network. Examples of the network 130 can include but are not limited to a cable network, an optical fiber network, a telecommunications network, an intranet, the Internet, a local area network (LAN), a wide area network (WAN), a wireless local area network (WLAN), a metropolitan area network (MAN), a public switched telephone network (PSTN), a Bluetooth network, a ZigBee network, near field communication (NFC), an intra-device bus, an intra-device line, or any combination thereof.

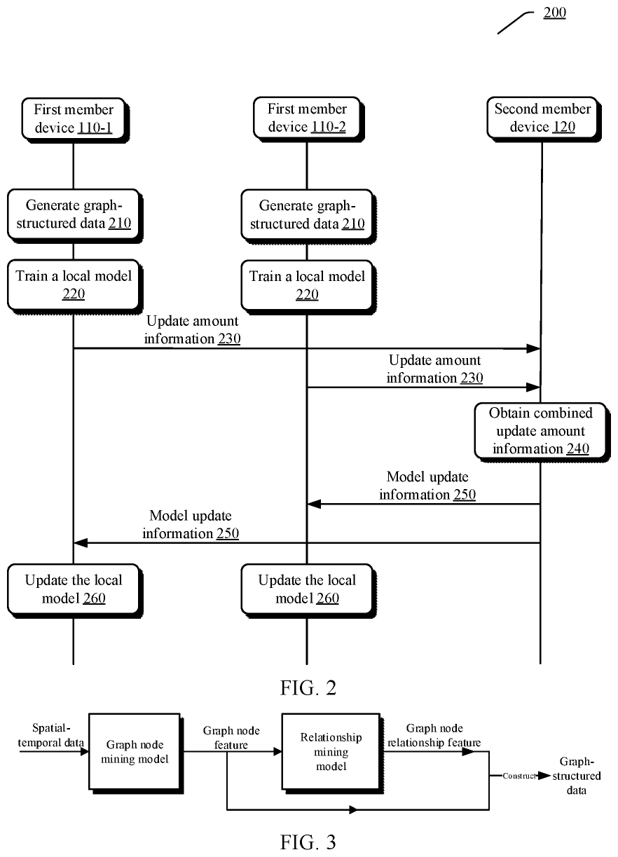

FIG. 2 is a signal communication diagram illustrating an example 200 of a federated learning method based on a graph neural network according to an implementation of the present specification.

In the example shown in FIG. 2, the federated learning method can be performed by a federated learning system. The federated learning system can include at least two first member devices 110 and a second member device 120. For example, the first member device is equivalent to a participant, and the second member device is equivalent to a server. Each first member device and each second member device collaborate to iteratively execute a federated learning process until an iteration termination condition is satisfied and each first member device locally trains a final graph neural network model. Examples of the iteration termination condition, for example, can include but are not limited to reaching a predetermined number of iterations, or a model prediction error of a local graph neural network model of each first member device falls within a predetermined range.

Each first member device has local spatial-temporal data and a graph neural network model, a network structure of the graph neural network model is a graph neural network structure, and the graph neural network can include a graph structure including nodes (vertices) and edges. The local spatial-temporal data of each first member device can be used as a training sample to train the local graph neural network model.

The graph neural network model can include a plurality of model structure types, for example, a graph convolutional network (GCN), a graph attention network (GAT), and a Graph-SAGE. In an example, model structure types of the local graph neural network models of the first member devices 110 can be same. For example, the local graph neural network models of all the first member devices are GCN models. In another example, model structure types of the local graph neural network models of the first member devices 110 are different. For example, local graph neural network models of some first member devices 110 are GCN models, local graph neural network models of some first member devices 110 are GAT models, and local graph neural network models of some first member devices 110 are Graph-SAGE models.

As shown in FIG. 2, during each iteration, in 210, each first member device performs mining of graph nodes and mining of a relationship among graph nodes, e.g., edge mining, on local spatial-temporal data to generate graph-structured data.

In some implementations of the present specification, due to the properties of the temporal dimension and the spatial dimension of the spatial-temporal data, there can be association between different spatial-temporal data. Therefore, in addition to information about the spatial-temporal data itself, information included in the spatial-temporal data can further include association information with other spatial-temporal data. The spatial-temporal data can be represented in Euclidean space. When the spatial-temporal data is represented in Euclidean space, a represented meaning includes only the information about the spatial-temporal data, and cannot represent the association information with other spatial-temporal data. The spatial-temporal data is converted into graph-structured data for representation, so that the information about the spatial-temporal data and the association information with other spatial-temporal data that are included in the spatial-temporal data can be explicitly represented. Information about each piece of spatial-temporal data can be represented by using a graph node in the graph-structured data, and an association relationship between each piece of spatial-temporal data and other spatial-temporal data can be represented by using a graph node relationship.

The graph-structured data is used to describe concepts and a relationship among the concepts in the physical world. The concept in the physical world can be represented by using a vertex, and the relationship among the concepts can be represented by using an edge. Therefore, the graph-structured data can be a relationship diagram constructed by using vertices and edges.

In some implementations of the present specification, the graph-structured data can include graph nodes as vertices and graph node relationships as edges. The graph node can include an event, an account, etc. that are mined from the spatial-temporal data, and each graph node can represent a concept in the physical world such as an event or an account. The graph node relationship can represent association between two graph nodes. The graph node relationship can include association between events, association between accounts, etc. The graph node relationship can include association for the temporal dimension and association for the spatial dimension. For example, a fund is transferred from one account to another account for storage, and the fund associates the two accounts in the temporal dimension, so that there is association between the two accounts.

For construction of the graph-structured data, after graph nodes and graph node relationships are mined, each graph node can be used as a node or vertex, and each graph node relationship can be used as an edge. When there is a graph node relationship among two graph nodes, vertices represented by the two graph nodes can be connected by using an edge representing the graph node relationship. When two graph nodes are connected by using a plurality of edges, it indicates that there are a plurality of graph node relationships among the two graph nodes. In an example, when there are a plurality of edges between two graph nodes, the plurality of edges between the two graph nodes can be integrated into one edge for representation.

In an example, mining of graph nodes can be performed before mining of a relationship among graph nodes on the spatial-temporal data. For example, mining of graph nodes can be first performed on the spatial-temporal data, to obtain mined graph node features used to represent graph nodes. Then, mining of a relationship among graph nodes can be performed on the graph node features, to obtain graph node relationship features used to represent relationships among the graph nodes.

FIG. 3 is a schematic diagram illustrating an example 300 of performing mining of graph nodes and mining of a relationship among graph nodes on spatial-temporal data according to an implementation of the present specification.

As shown in FIG. 3, a graph node mining model and a relationship mining model can be locally configured for each first member device. Each first member device can input local spatial-temporal data into a local graph node mining model, and the graph node mining model can perform mining of graph nodes on the input spatial-temporal data. Mining of graph nodes is to find graph nodes included in the spatial-temporal data, and to perform feature extraction on the found graph nodes, so that the graph node mining model can output graph node features corresponding to the mined graph nodes.

A convolutional neural network can be used for the graph node mining model, and a convolutional layer and a pooling layer of the convolutional neural network can perform feature extraction on the spatial-temporal data. In addition, other types of neural network and other structural networks can also be used for the graph node mining model. No limitation is imposed herein.

The graph node mining model can output graph node features in a matrix form. In the output matrix, each row represents one graph node feature, and each column represents one dimension in the graph node feature. All output graph node features have a same dimension. Graph node features extracted by the graph node mining models of the first member devices have a same dimension, and therefore output matrices have a same dimension.

The graph node features output by the graph node mining model can input into the relationship mining model, and the relationship mining model can perform mining of a relationship among graph nodes on the input graph node features, to obtain graph node relationship features used to represent relationships among the graph nodes.

In a relationship mining method, at least one relationship mining algorithm of a Pearson correlation coefficient (PCC) algorithm, a k-nearest neighbors (K-NN) algorithm, a distance algorithm, or a phase locking value (PLV) algorithm can be configured in the relationship mining model, and each relationship mining algorithm can be used to mine a relationship feature.

For the PCC algorithm, a PCC can be used to measure linear correlation between two graph node features. A value range of the PCC can be [−1, 1]. PCC=1 indicates full linear positive correlation, PCC=0 indicates no linear correlation, and PCC=−1 indicates full linear negative correlation. The PCC between two graph node features can be calculated based on the following equation:

$${ρ}_{X , Y} = \frac{cov ( X , Y )}{{σ}_{X} {σ}_{Y}}$$

X and Y represent the graph node features, ρ_{X,Y} represents the PCC, cov(X, Y) represents a covariance between X and Y, σ_{X} represents a standard deviation of X, and σ_{Y} represents a standard deviation of Y.

For the distance algorithm, each graph node feature can be represented by using a feature vector, each feature vector used to represent the graph node feature can be represented by using a vertex in Euclidean space, and a distance between two vertices in Euclidean space can represent correlation between the two vertices. Therefore, a distance between vertices corresponding to graph node features can be calculated, and a type of the calculated distance can include the Euclidean distance, the Manhattan distance, the cosine distance, etc. A smaller distance indicates larger correlation between two graph node features. A larger distance indicates smaller correlation between two graph node features.

For the K-NN algorithm, when each graph node feature is represented in Euclidean space, for a vertex corresponding to each graph node feature in Euclidean space, k neighbors adjacent to the vertex can be determined by using the K-NN algorithm, and it can be considered that there is correlation between all the k neighbors and the vertex. Therefore, there is correlation between graph node features corresponding to the k neighbors and the graph node feature corresponding to the vertex. The determined k neighbors are also vertices corresponding to graph node features, and a number k of the determined neighbors can be customized.

For the PLV algorithm, a PLV can be used to indicate an overall trend of a phase difference between two graph node features. When PLV=1, the phase difference between the two graph node features is a constant, that is, the two graph node features are totally synchronized, that is, the two graph node features are consistent. When PLV=0, the phase difference is evenly distributed on a complex-plane unit circle based on time, that is, the two graph node features are not synchronized, that is, the two graph node features have poor correlation. When the PLV is between 0 and 1, it indicates that the phase difference between the two graph node features has an “overall trend” property. When the PLV is closer to 1, it indicates that the phase difference between the two graph node features is more synchronized, that is, correlation between the two graph node features is greater.

In an example, only one relationship mining algorithm can be configured in the relationship mining model, and the configured relationship mining algorithm can be any one of a PCC algorithm, a K-NN algorithm, a distance algorithm, or a PLV algorithm. In this example, the relationship mining model can invoke the configured relationship mining algorithm to perform mining of a relationship among graph nodes on the input graph node features.

In an example, a plurality of relational mining algorithms can be configured in the relational mining model. The relationship mining model can invoke the plurality of configured relationship mining algorithms to separately perform mining of a relationship among graph nodes on the input graph node features, the relationship mining algorithms are independently executed, and each relationship mining algorithm can correspondingly output an obtained group of graph node relationship features. Each group of graph node relationship features can include a plurality of graph node relationship features, and graph node relationship features that belong to a same group are obtained by using a same relationship mining algorithm.

After a plurality of groups of graph node relationship features correspondingly mined by using various relationship mining algorithms are obtained, the plurality of groups of graph node relationship features can be compared to determine an optimal group of graph node relationship features. In a comparison method, numbers of graph node relationship features included in all the groups of graph node relationship features can be compared. If the number of included graph node relationship features is larger, it can be considered that a corresponding relationship mining algorithm has a better a mining effect, and an optimal group of graph node relationship features is correspondingly output. In a comparison method, a group with a best training effect can be determined as an optimal group of graph node relationship features based on a training effect corresponding to each group of graph node relationship features.

After the optimal group of graph node relationship features is determined, the determined group of graph node relationship features can be output as the graph node relationship features between the graph nodes.

In an example, a plurality of relational mining algorithms can be configured in the relational mining model. The relationship mining model can determine an adapted relationship mining algorithm from the plurality of configured relationship mining algorithms based on a service type to which the spatial-temporal data belongs, and there can be one or more determined adapted relationship mining algorithms. For example, when the service type to which the spatial-temporal data belongs is an intelligent monitoring service, it can be determined that the adapted relationship mining algorithm is the K-NN algorithm. When the service type to which the spatial-temporal data belongs is a service that involves a type such as an electroencephalogram or a signal, it can be determined that the adapted relationship mining algorithm is the PLV algorithm.

Then, in the relationship mining model, mining of a relationship among graph nodes can be performed on the input graph node features by using the determined adapted relationship mining algorithm, to obtain the graph node relationship features. When there is only one adapted relationship mining algorithm, graph node relationship features mined by the adapted relationship mining algorithm can be directly output. When there are a plurality of adapted relationship mining algorithms, all obtained groups of graph node relationship features can be compared based on the method above, to determine an optimal group of graph node relationship features. Then, the determined group of graph node relationship features is output as the graph node relationship features between the graph nodes.

Referring back to FIG. 3, when the graph node features output by the graph node mining model and the graph node relationship features output by the relationship mining model are obtained, the graph-structured data can be generated based on the obtained graph node features and the obtained graph node relationship features.

In a generation method, each graph node feature can be represented by using a node or vertex, and each graph node relationship feature can be represented by using an edge. When there is association represented by one graph node relationship feature between two graph nodes represented by two graph node features, the two graph nodes can be connected by using one edge, and the edge is one graph node relationship feature. When vertices corresponding to all graph node features are connected by using edges corresponding to all graph node relationship features, an obtained graph structure is graph-structured data.

Referring back to FIG. 2, in 220, each first member device 110 trains the local graph neural network model by using the local graph-structured data, to obtain update amount information for the local graph neural network model.

In some implementations of the present specification, the graph neural network model can perform embedding learning on the nodes and edge relationships in the graph-structured data based on a graph representation learning method. Graph representation learning is used to represent the entire graph-structured data in a form of a low-dimensional, real-valued, and dense vector, and is used to analyze the entire graph-structured data, including graph classification, similarity between graphs, etc. Graph representation learning methods can include deepwalk, node2vec, etc.

The graph neural network model can obtain a corresponding prediction result based on a learning result of embedding learning, and then calculate a loss function based on the prediction result and a label of the spatial-temporal data. For a method for calculating the loss function, a gradient descent algorithm can be used to obtain gradient information, where the gradient information can reflect a degree of inconsistency between the prediction result and the label, so that the update amount information for the graph neural network model can be obtained based on the gradient information. The update amount information is an update amount of a weight matrix for the graph neural network model. The update amount information can be presented in a form of a matrix. A dimension of the matrix of the update amount information is same as a dimension of the weight matrix in the graph neural network model of each first member device, so that an operation such as addition can be performed between the update amount information and the weight matrix in the graph neural network model, thereby updating the weight matrix in the graph neural network model.

In 230, each first member device 110 can send the locally obtained update amount information to the second member device.

In 240, after receiving the update amount information sent by each first member device, the second member device can obtain combined update amount information based on the received update amount information.

In an example, a method for combining the received update amount information can include an average calculation method. In this example, average calculation can be performed on the received update amount information to obtain averaged combined update amount information. In addition, the method for combining the update amount information in some implementations of the present specification can further include another method such as variance calculation. No limitation is imposed herein.

In an example, sampling can be performed on the received update amount information, and an amount of update amount information obtained through sampling is less than an amount of received update amount information. Then, average calculation is performed on the plurality of pieces of update amount information obtained through sampling, to obtain the averaged combined update amount information. Through sampling processing, the combined update amount information can be reduced, thereby reducing a calculation amount.

In an example, the received update amount information can be evaluated to determine, from the update amount information, update amount information that has a less satisfying training effect and/or that has an exception. For example, if update amount information received from a first member device 110 is obviously less than update amount information received from another first member device 110, it can be considered that a training effect of the first member device is less satisfying. For another example, if update amount information received from one first member device is obviously greater than update amount information received from another first member device, it can be considered that the update amount information sent by the first member device has an exception.

In an example, the determined update amount information that has a less satisfying training effect and/or that has an exception can be removed from the received update amount information, and average calculation is performed on the update amount information obtained after removement, to obtain the averaged combined update amount information.

In 250, the second member device 120 distributes corresponding model update information to each first member device 110 based on the combined update amount information.

In 260, each first member device updates the local graph neural network model based on the received model update information.

In an example, the second member device can distribute the combined update amount information to each first member device as model update information. After receiving the combined update amount information, each first member device can update the local graph neural network model based on the combined update amount information. For example, for each graph neural network model, addition calculation can be performed on a weight matrix in the graph neural network model and a matrix of a combined update amount, to obtain an updated weight matrix.

In an example, model structure types of the local graph neural network models of the first member devices are same, the second member device also has a local graph neural network model, and a model structure type of the local graph neural network model of the second member device are same as the model structure types of the local graph neural network models of the first member devices.

In this example, after obtaining the combined update amount information, the second member device can update the local graph neural network model of the second member device based on the combined update amount information, and then separately send the updated graph neural network model to each first member device. In this example, the updated graph neural network model is delivered to each first member device as model update information.

Each first member device can update the local graph neural network model based on the received graph neural network model. For example, the received graph neural network model can be used to replace the local graph neural network model, to serve as a new local graph neural network model.

In the technical solution in some implementations of the present specification, a model based on a graph neural network is trained in a federated learning framework, and association features between spatial-temporal data used as training samples are fully mined for model training. In addition, federated learning ensures security of local spatial-temporal data of each first member device.

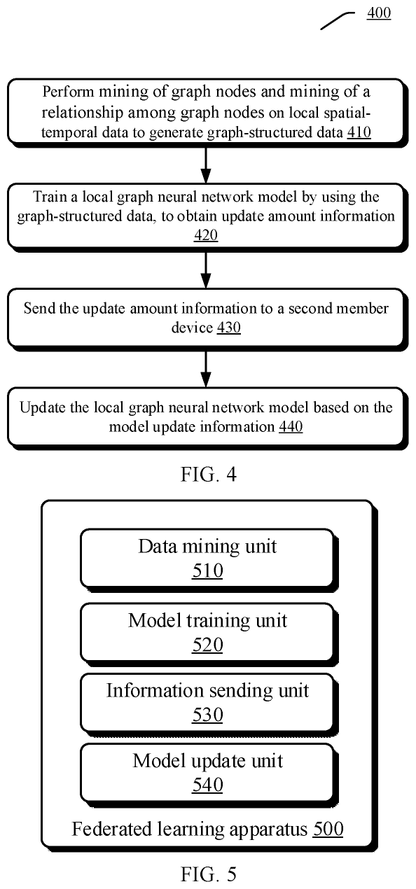

FIG. 4 is a flowchart illustrating an example 400 of a federated learning method based on a graph neural network according to an implementation of the present specification.

The federated learning method shown in FIG. 4 is performed by a first member device 110 in a federated learning system. The federated learning system includes at least two first member devices 110 and a second member device 120. Each first member device 110 has spatial-temporal data used to train a local graph neural network model.

As shown in FIG. 4, in 410, mining of graph nodes and mining of a relationship among graph nodes are performed on local spatial-temporal data to generate graph-structured data including graph nodes as vertices and graph node relationships as edges.

In 420, the local graph neural network model is trained by using the graph-structured data, to obtain update amount information for the local graph neural network model.

In 430, the update amount information is sent to the second member device for the second member device to obtain combined update amount information based on the received update amount information, and to separately send corresponding model update information to each first member device based on the combined update amount information.

In 440, the local graph neural network model is updated based on the corresponding model update information.

In an example, mining of graph nodes can be performed on the local spatial-temporal data by using a graph node mining model, to obtain graph node features corresponding to mined graph nodes; mining of a relationship among graph nodes can be performed on the obtained graph node features by using a relationship mining model, to obtain graph node relationship features used to represent relationships among the graph nodes; and the graph-structured data is generated based on the obtained graph node features and the obtained graph node relationship features.

In an example, mining of a relationship among graph nodes can be separately performed on the obtained graph node features by using a plurality of relationship mining algorithms configured in the relationship mining model, to obtain a group of graph node relationship features mined by using each relationship mining algorithm; the obtained groups of graph node relationship features can be compared to determine an optimal group of graph node relationship features; and the determined group of graph node relationship features is output as the graph node relationship features between the graph nodes.

FIG. 5 is a block diagram illustrating an example of a federated learning apparatus based on a graph neural network 500 according to an implementation of the present specification.

The federated learning apparatus 500 shown in FIG. 5 can be applied to a first member device in a federated learning system. The federated learning system includes at least two first member devices and a second member device. Each first member device has spatial-temporal data used to train a local graph neural network model.

As shown in FIG. 5, the federated learning apparatus 500 includes a data mining unit 510, a model training unit 520, an information sending unit 530, and a model update unit 540.

The data mining unit 510 can be configured to perform mining of graph nodes and mining of a relationship among graph nodes on local spatial-temporal data to generate graph-structured data including graph nodes as vertices and graph node relationships as edges.

The model training unit 520 can be configured to train the local graph neural network model by using the graph-structured data, to obtain update amount information for the local graph neural network model.

The information sending unit 530 can be configured to send the update amount information to the second member device for the second member device to obtain combined update amount information based on the received update amount information, and to separately send corresponding model update information to each first member device based on the combined update amount information.

The model update unit 540 can be configured to update the local graph neural network model based on the corresponding model update information.

In an example, the data mining unit 510 can be further configured to: perform mining of graph nodes on the local spatial-temporal data by using a graph node mining model, to obtain graph node features corresponding to mined graph nodes; perform mining of a relationship among graph nodes on the obtained graph node features by using a relationship mining model, to obtain graph node relationship features used to represent relationships among the graph nodes; and generate the graph-structured data based on the obtained graph node features and the obtained graph node relationship features.

In an example, the data mining unit 510 can be further configured to: separately perform mining of a relationship among graph nodes on the obtained graph node features by using a plurality of relationship mining algorithms configured in the relationship mining model, to obtain a group of graph node relationship features mined by using each relationship mining algorithm; compare obtain groups of graph node relationship features to determine an optimal group of graph node relationship features; and output the determined group of graph node relationship features as the graph node relationship features between the graph nodes.

For the federated learning system provided in some implementations of the present specification, references can be made to FIG. 1. For operations performed by each first member device and the second member device in the federated learning system, references can be made to various operations and functions described in FIG. 1 to FIG. 5.

The implementations of the federated learning method and apparatus based on a graph neural network according to the implementations of the present specification are described above with reference to FIG. 1 to FIG. 5.

The federated learning apparatus based on a graph neural network in some implementations of the present specification can be implemented by using hardware, or can be implemented by using software or a combination of hardware and software. Taking software implementation as an example, a logical apparatus is implemented by reading, by using a processor of a device where the apparatus is located, corresponding computer program instructions in a memory into an internal memory for running. In some implementations of the present specification, for example, the federated learning apparatus based on a graph neural network can be implemented by using an electronic device.

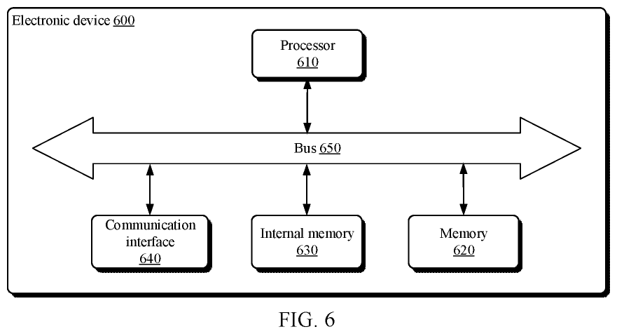

FIG. 6 is a block diagram illustrating an electronic device 600 for implementing a federated learning method according to an implementation of the present specification.

As shown in FIG. 6, the electronic device 600 can include at least one processor 610, a memory (for example, a non-volatile memory) 620, an internal memory 630, and a communication interface 640, and the at least one processor 610, the memory 620, the internal memory 630, and the communication interface 640 are connected together by using a bus 650. The at least one processor 610 executes at least one computer readable instruction (that is, the element implemented in a form of software) stored or encoded in the memory.

In an implementation, when the computer executable instruction stored in the memory is executed, the at least one processor 610 is enabled to: perform mining of graph nodes and mining of a relationship among graph nodes on local spatial-temporal data to generate graph-structured data including graph nodes as vertices and graph node relationships as edges; train the local graph neural network model by using the graph-structured data, to obtain update amount information for the local graph neural network model; send the update amount information to the second member device for the second member device to obtain combined update amount information based on the received update amount information, and to separately send corresponding model update information to each first member device based on the combined update amount information; and update the local graph neural network model based on the corresponding model update information.

It should be understood that, when the computer executable instruction stored in the memory is executed, the at least one processor 610 is enabled to perform various operations and functions described with reference to FIG. 1 to FIG. 5 in the implementations of the present specification.

Based on an implementation, a program product such as a machine readable medium is provided. The machine readable medium can have instructions (that is, the element implemented in a form of software). When the instructions are executed by a machine, the machine is enabled to perform various operations and functions described with reference to FIG. 1 to FIG. 5 in the implementations of the present specification.

For example, a system or an apparatus equipped with a readable storage medium can be provided, and software program code for implementing a function of any one of the implementations is stored in the readable storage medium, so that a computer or a processor of the system or the apparatus reads and executes the instructions stored in the readable storage medium.

In this case, the program code read from the readable medium can implement a function of any one of the implementations. Therefore, the machine readable code and the readable storage medium that stores the machine readable code constitute a part of the present disclosure.

Computer program code required for operating each part of the present specification can be written in any one or more program languages, including object-oriented programming languages such as Java, Scala, Smalltalk, Eiffel, JADE, Emerald, C++, C#, VB, NET, and Python, conventional programming languages such as C language, Visual Basic 2003, Perl, COBOL 2002, PHP, and ABAP, dynamic programming languages such as Python, ruby, and Groovy, or other programming languages. The program code can be run on a user computer, or run on a user computer as a stand-alone software package, or partially run on a user computer and partially run on a remote computer, or all run on a remote computer or a server. In the latter case, the remote computer can be connected to the user computer in any network form, such as a local area network (LAN) or a wide area network (WAN), or connected to an external computer (for example, via the Internet), or used as a service in a cloud computing environment, such as Software as a Service (SaaS).

Implementations of the readable storage medium include a floppy disk, a hard disk, a magnetic disk, an optical disc (such as a compact disc read-only memory (CD-ROM), a compact disc-recordable (CD-R), a compact disc-rewritable (CD-RW), a digital versatile disc-read-only memory (DVD-ROM), a digital versatile disc-random access memory (DVD-RAM), a digital versatile disc-rewritable (DVD-RW), a digital versatile disc-rewritable (DVD-RW)), a magnetic tape, a non-volatile memory card, and a ROM. Optionally, program code can be downloaded from a server computer or cloud by a communication network.

Specific implementations of the present specification are described above. Other implementations fall within the scope of the appended claims. In some cases, the actions or steps described in the claims can be performed in an order different from the order in the implementations and can still achieve the desired results. In addition, the process depicted in the accompanying drawings does not necessarily require a particular execution order to achieve the desired results. In some implementations, multi-tasking and parallel processing can be advantageous.

Not all steps and units in the processes and system structural diagrams are required. Some steps or units can be ignored based on actual needs. A sequence for performing steps is not fixed, and can be determined based on needs. The apparatus structure described in the implementations can be a physical structure, or can be a logical structure, that is, some units can be implemented by a same physical entity, or some units can be implemented by a plurality of physical entities, or can be implemented jointly by some components in a plurality of independent devices.

The term “example” used throughout the present specification means “used as an example, an instance, or an illustration”, and does not mean “preferred” or “advantageous” over other implementations. For the purpose of providing an understanding of the described technologies, the specific implementations include specific details. However, these technologies can be implemented without these specific details. In some examples, well-known structures and apparatuses are shown in block diagrams to avoid difficulties in understanding the concept of the described implementations.

Optional implementations of the implementations of the present specification are described in detail above with reference to the accompanying drawings. However, the implementations of the present specification are not limited to specific details in the implementations above. Within a technical concept scope of the implementations of the present specification, a plurality of simple variations can be made to the technical solutions of the implementations of the present specification, and these simple variations are all within the protection scope of the implementations of the present specification.

The descriptions of the content of the present specification are provided to enable any person of ordinary skill in the art to implement or use the content of the present specification. For a person of ordinary skill in the art, various modifications made to the content of the present specification are obvious. In addition, the general principles defined in the present specification can be applied to other variations without departing from the protection scope of the content of the present specification. Therefore, the content of the present specification is not limited to the examples and designs described in the present specification, but is consistent with the widest range of principles and novelty features that are disclosed in the present specification.

What is claimed is:

1. A federated learning method, the federated learning method being performed by a federated learning system, the federated learning system including at least two first member devices and a second member device, each first member device having spatial-temporal data, and the federated learning method comprising:
by each first member device,
performing mining of graph nodes and mining of a relationship among graph nodes on local spatial-temporal data to generate graph-structured data including graph nodes as vertices and graph node relationships as edges;
training the local graph neural network model by using the graph-structured data, to obtain update amount information for the local graph neural network model; and
sending the update amount information to the second member device;
receiving model update information from the second member device; and
updating the local graph neural network model based on the model update information.

2. The federated learning method according to claim 1, wherein the performing mining of graph nodes and mining of a relationship among graph nodes on the local spatial-temporal data to generate the graph-structured data including graph nodes as vertices and graph node relationships as edges includes:
performing mining of graph nodes on the local spatial-temporal data by using a graph node mining model, to obtain graph node features corresponding to mined graph nodes;
performing mining of a relationship among graph nodes on the obtained graph node features by using a relationship mining model, to obtain graph node relationship features used to represent relationships among the graph nodes; and
generating the graph-structured data based on the obtained graph node features and the obtained graph node relationship features.

3. The federated learning method according to claim 2, wherein at least one relationship mining algorithm of a Pearson correlation coefficient (PCC) algorithm, a k-nearest neighbors (K-NN) algorithm, a distance algorithm, or a phase locking value (PLV) algorithm is configured in the relationship mining model.

4. The federated learning method according to claim 3, wherein a plurality of relationship mining algorithms are configured in the relationship mining model, and the performing mining of a relationship among graph nodes on the obtained graph node features by using the relationship mining model, to obtain the graph node relationship features used to represent the relationships among the graph nodes includes:
separately performing mining of a relationship among graph nodes on the obtained graph node features by using the plurality of relationship mining algorithms configured in the relationship mining model, to obtain a group of graph node relationship features mined by using each relationship mining algorithm;
comparing obtained groups of graph node relationship features to determine a target group of graph node relationship features; and
outputting the determined group of graph node relationship features as the graph node relationship features between the graph nodes.

5. The federated learning method according to claim 1, wherein model structure types of the local graph neural network models of the first member devices are different.

6. The federated learning method according to claim 1, comprising:
by the second member device,
receiving the update amount information from each first member device;
obtaining the combined update amount information based on the update amount information received from each first member device; and
separately sending corresponding model update information to each first member device based on the combined update amount information.

7. The federated learning method according to claim 6, wherein the obtaining the combined update amount information based on the update amount information includes:
performing average calculation on the received update amount information, to obtain averaged combined update amount information.

8. The federated learning method according to claim 6, wherein the separately sending the corresponding model update information to each first member device including separately sending the corresponding model update information that includes the combined update amount information, and
wherein the updating the local graph neural network model based on the model update information includes updating the local graph neural network model based on the combined update amount information included in the model update information.

9. The federated learning method according to claim 1, wherein model structure types of the local graph neural network models of the first member devices are same; and
the separately sending the corresponding model update information to each first member device based on the combined update amount information for each first member device to update the local graph neural network model based on the corresponding model update information includes:
updating a local graph neural network model of the second member device based on the combined update amount information, a model structure type of the graph neural network model of the second member device being same as the model structure types of the local graph neural network models of the first member devices;
separately sending the updated graph neural network model to each first member device for each first member device to update the local graph neural network model based on the received graph neural network model.

10. A federated learning system, comprising at least two first member devices and a second member device, each first member device having spatial-temporal data, and
each first member device having one or more processors and one or more memory devices, the one or more memory devices of the first member device having executable instructions stored thereon, which when executed by the one or more processors of the first member device, enable the one or more processors of the first member device to implement acts including:
performing mining of graph nodes and mining of a relationship among graph nodes on local spatial-temporal data to generate graph-structured data including graph nodes as vertices and graph node relationships as edges;
training the local graph neural network model by using the graph-structured data, to obtain update amount information for the local graph neural network model; and
sending the update amount information to the second member device;
receiving model update information from the second member device; and
updating the local graph neural network model based on the model update information.

11. The federated learning system according to claim 10, wherein the performing mining of graph nodes and mining of a relationship among graph nodes on the local spatial-temporal data to generate the graph-structured data including graph nodes as vertices and graph node relationships as edges includes:
performing mining of graph nodes on the local spatial-temporal data by using a graph node mining model, to obtain graph node features corresponding to mined graph nodes;
performing mining of a relationship among graph nodes on the obtained graph node features by using a relationship mining model, to obtain graph node relationship features used to represent relationships among the graph nodes; and
generating the graph-structured data based on the obtained graph node features and the obtained graph node relationship features.

12. The federated learning system according to claim 11, wherein at least one relationship mining algorithm of a Pearson correlation coefficient (PCC) algorithm, a k-nearest neighbors (K-NN) algorithm, a distance algorithm, or a phase locking value (PLV) algorithm is configured in the relationship mining model.

13. The federated learning system according to claim 12, wherein a plurality of relationship mining algorithms are configured in the relationship mining model, and the performing mining of a relationship among graph nodes on the obtained graph node features by using the relationship mining model, to obtain the graph node relationship features used to represent the relationships among the graph nodes includes:
separately performing mining of a relationship among graph nodes on the obtained graph node features by using the plurality of relationship mining algorithms configured in the relationship mining model, to obtain a group of graph node relationship features mined by using each relationship mining algorithm;
comparing obtained groups of graph node relationship features to determine a target group of graph node relationship features; and
outputting the determined group of graph node relationship features as the graph node relationship features between the graph nodes.

14. The federated learning system according to claim 10, wherein the second member device includes one or more processors and one or more memory devices, the one or more memory devices of the second member device having executable instructions stored thereon, which when executed by the one or more processors of the second member device, enable the one or more processors of the second member device to implement acts including:
receiving the update amount information from each first member device;
obtaining the combined update amount information based on the update amount information received from each first member device; and
separately sending corresponding model update information to each first member device based on the combined update amount information.

15. The federated learning system according to claim 14, wherein the obtaining the combined update amount information based on the update amount information includes:
performing average calculation on the received update amount information, to obtain averaged combined update amount information.

16. The federated learning system according to claim 14, wherein the separately sending the corresponding model update information to each first member device including separately sending the corresponding model update information that includes the combined update amount information, and
wherein the updating the local graph neural network model based on the model update information includes updating the local graph neural network model based on the combined update amount information included in the model update information.

17. A computer-readable storage medium, the computer-readable storage medium storing computer executable instructions, the computer executable instructions when executed by one or more processors, enabling the one or more processors to deploying a federated learning system, the federated learning system including at least two first members and a second member,
where each first member in the federated learning system is configured to implement actions including:
performing mining of graph nodes and mining of a relationship among graph nodes on local spatial-temporal data to generate graph-structured data including graph nodes as vertices and graph node relationships as edges;
training the local graph neural network model by using the graph-structured data, to obtain update amount information for the local graph neural network model; and
sending the update amount information to the second member;
receiving model update information from the second member; and
updating the local graph neural network model based on the model update information.

18. The computer-readable storage medium according to claim 17, wherein the performing mining of graph nodes and mining of a relationship among graph nodes on the local spatial-temporal data to generate the graph-structured data including graph nodes as vertices and graph node relationships as edges includes:
performing mining of graph nodes on the local spatial-temporal data by using a graph node mining model, to obtain graph node features corresponding to mined graph nodes;
performing mining of a relationship among graph nodes on the obtained graph node features by using a relationship mining model, to obtain graph node relationship features used to represent relationships among the graph nodes; and
generating the graph-structured data based on the obtained graph node features and the obtained graph node relationship features.

19. The computer-readable storage medium according to claim 18, wherein at least one relationship mining algorithm of a Pearson correlation coefficient (PCC) algorithm, a k-nearest neighbors (K-NN) algorithm, a distance algorithm, or a phase locking value (PLV) algorithm is configured in the relationship mining model.

20. The computer-readable storage medium according to claim 17, wherein the second member is configured to implement actions including:
receiving the update amount information from each first member;
obtaining the combined update amount information based on the update amount information received from each first member; and
separately sending corresponding model update information to each first member based on the combined update amount information.
